(19) United States
(12) Patent Application Publication
(10) Pub. No.: US 2016/0271896 A1
(43) Pub. Date: Sep. 22, 2016

(54) METHOD OF MANUFACTURING SOLE WITH SHOE NAIL MADE OF DIFFERENT MATERIAL

(71) Applicant: Teng-Jen YANG, Taichung City (TW)

(72) Inventor: Teng-Jen YANG, Taichung City (TW)

(21) Appl. No.: 15/168,231

(22) Filed: May 30, 2016

Related U.S. Application Data
(62) Division of application No. 14/522,588, filed on Oct. 24, 2014.

(51) Int. Cl. B29D 35/12; A43B 13/04

(52) U.S. Cl. CPC B29D 35/122; A43B 13/04

(57) ABSTRACT

A method of manufacturing a sole with shoe nails made of different materials is provided. The method includes pre-forming shoe nails, putting the shoe nails in an injection molding mold, applying a surface treatment agent and an adhesive glue, injecting the heated molten sole material into a mold, binding the sole material and the shoe nails with the adhesive glue, and performing a cooling process to cause the sole material to solidify and turn into a sole and cause the adhesive glue to solidify and couple the sole and shoe nails together. The method enables a sole with shoe nails to be quickly manufactured so easily that it increases production efficiency and economic benefits.

This is a divisional application of and claims priority to the U.S. application Ser. No. 14/522,588, the disclosure of which is incorporated by reference herein.

### BACKGROUND OF THE INVENTION

1. Technical Field

The present invention relates to methods of manufacturing parts and components of shoes, and more particularly, to a method of manufacturing a sole with shoe nails made of different materials.

2. Description of Related Art

Shoe nails, also known as foot nails, are disposed mostly in a sole of a football shoe or a track and field sports shoe to reduce vibration, increase grip, and enhance control. Referring to FIG. 1, a conventional sole 10 with a plurality of shoe nails 11 coupled thereto. The shoe nails 11 are made of metal. The shoe nails 11 are each fastened to the sole 10 by a bolt 111, and then the sole 10 is coupled to a shoe body. The aforesaid manufacturing process is intricate and thus unfit for mass production.

In view of this, a method of manufacturing a sole with shoe nails was disclosed, which requires performing an instance of injection molding using two types of plastic which are different in material characteristics in order to enhance production efficiency. However, although shoe nails are different from a sole in material characteristics, both the shoe nails and the sole are made of plastic; as a result, the grip of the shoe nails is not up to standard, and thus there is still room for improvement.

The prior art further discloses a sole with shoe nails made of rubber, wherein the sole is made of plastic, and the shoe nails are made of rubber. Since rubber differs from plastic in terms of forming conditions and manufacturing techniques, conventional forming techniques are unfit to form a rubber part and a plastic part simultaneously, and thus it is necessary to pre-form the rubber parts and the plastic part separately before performing a dispensing and adhering procedure or a coupling procedure on the rubber part and the plastic part separately. A failure to position the rubber part and the plastic part in place precisely and steadily during the dispensing step leads to low coupling stability and unsatisfactory coupling products.

### SUMMARY OF THE INVENTION

The present invention provides a method of manufacturing a sole with shoe nails made of different materials to overcome drawbacks of the prior art, namely intricate manufacturing process, insufficient grip, and low coupling stability.

In order to achieve the above and other objectives, the present invention provides a method of manufacturing a sole with shoe nails made of different materials. The method comprises the steps as follows:

shoe nail pre-forming step: forming shoe nails each having an outer surface and a coupling surface;

shoe nail feeding step: putting the pre-formed shoe nails in a first mold, wherein the first mold has a shaping chamber, and the shaping chamber has a slot, wherein the shoe nails are received in the shaping chamber, and the outer surfaces of the shoe nails abut against the shaping chamber, wherein a shaping space is defined by and between the shoe nails and the slot of the shaping chamber, after the shoe nails have been received in the shaping chamber;

surface treatment step: applying a liquid surface treatment agent to the coupling surface of each said shoe nail, wherein the surface treatment agent is a butanone-based treatment agent to be applied and dried thereafter;

adhesive glue feeding step: putting an adhesive glue in the shaping space, followed by applying the adhesive glue to the surface treatment agent;

die closing step: closing a second mold and the first mold, wherein the second mold has a corresponding forming portion which penetrates the second mold to form a feeding passage, with the corresponding forming portion facing the shaping chamber, so as to close the second mold and the first mold, seal the slot, and enable communication between the feeding passage and the shaping space;

sole material injecting step: heating and melting a sole material to a liquid state, followed by injecting the molten sole material into the shaping space via the feeding passage, wherein the sole material is different from the material of which the shoe nails are made;

melting binding step: adhering and coupling the heated molten sole material to a coupling surface of each said shoe nail by the adhesive glue after the sole material has been injected into the shaping space, wherein a cooling process is performed after the feeding of the sole material has stopped and the adhesive glue has melted, such that the cooling process causes the sole material to cool, cure, and turn into a sole and causes the adhesive glue to cool, solidify, and thus couple the sole and the shoe nails together; and die opening step: separating the first mold and the second mold, followed by taking out the shoe nails and the sole coupled together through the adhesive glue.

The present invention is characterized in that: pre-formed shoe nails and an adhesive glue are disposed in an injection forming mold, such that a sole is formed by the adhesive glue and an injection molding process and then adhered to the shoe nails, so easily as to increase production efficiency and economic benefits.

### BRIEF DESCRIPTION OF THE SEVERAL VIEWS OF THE DRAWINGS

FIG. 1 (PRIOR ART) is an exploded view of a conventional way of coupling a sole and a shoe nail together;

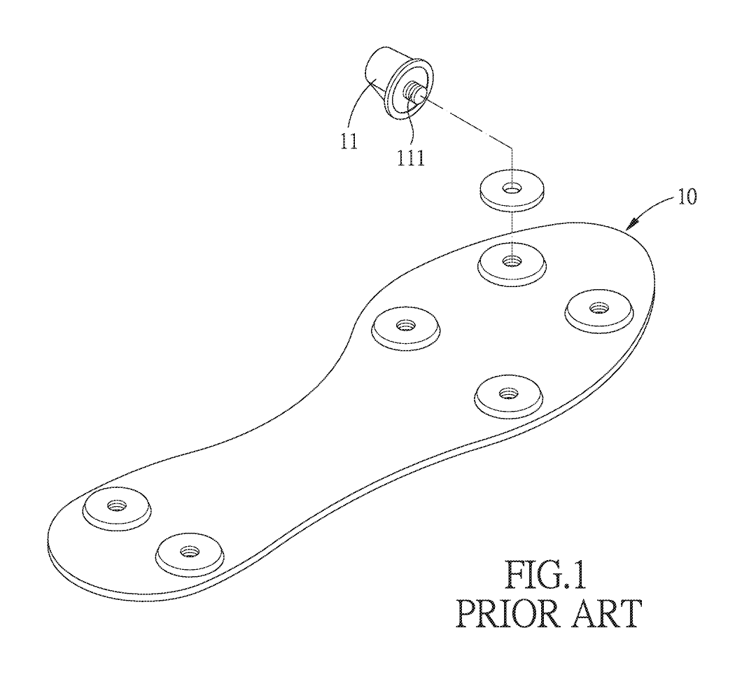

FIG. 2 is a flowchart of the present invention;

FIG. 3 is a schematic view of a shoe nail feeding step and an adhesive glue feeding step according to the present invention;

FIG. 4 is a schematic view of a die closing step according to the present invention;

FIG. 5 is a schematic view of a sole material injecting step according to the present invention;

FIG. 6 is a schematic view of a melting and binding step and a die opening step according to the present invention;

FIG. 7 is a perspective view of the structure of a finished product manufactured according to the present invention;

FIG. 8 is a cross-sectional view of the finished product manufactured according to the present invention;

FIG. 9 is a cross-sectional view of another finished product manufactured according to an embodiment of the present invention; and

FIG. 10 is a cross-sectional view of yet another finished product manufactured according to an embodiment of the present invention.

### DETAILED DESCRIPTION OF THE EMBODIMENT OF THE INVENTION

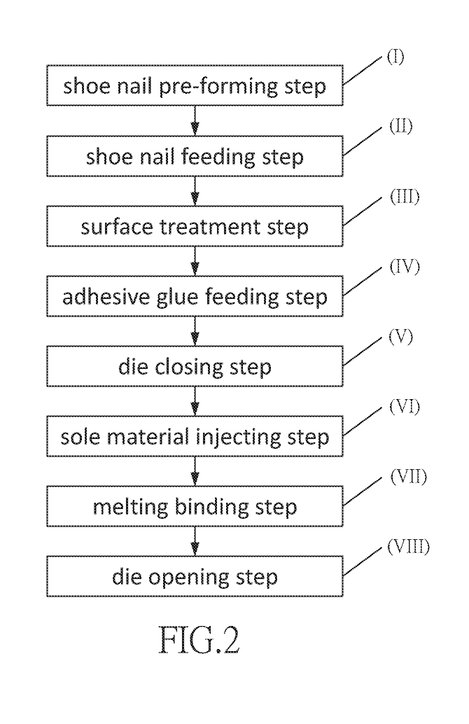

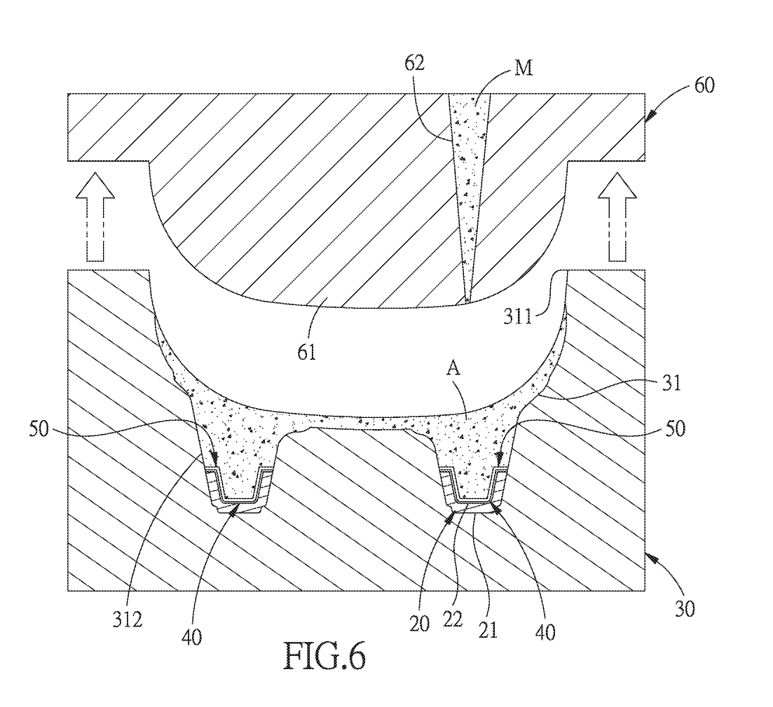

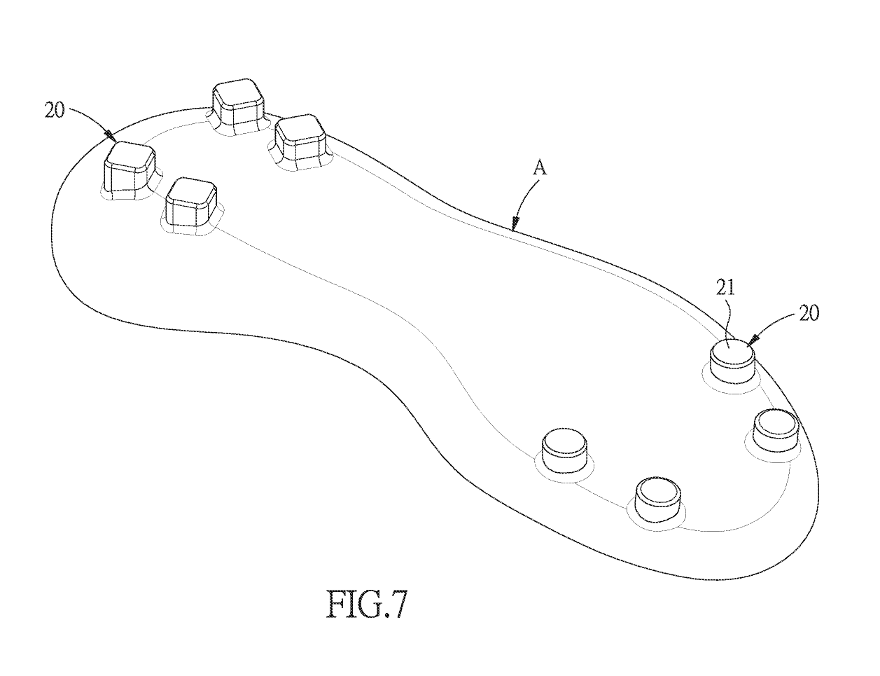

According to the present invention, a method of manufacturing a sole with shoe nails made of different materials is illustrated with FIG. 2 through FIG. 10 and comprises the steps below.

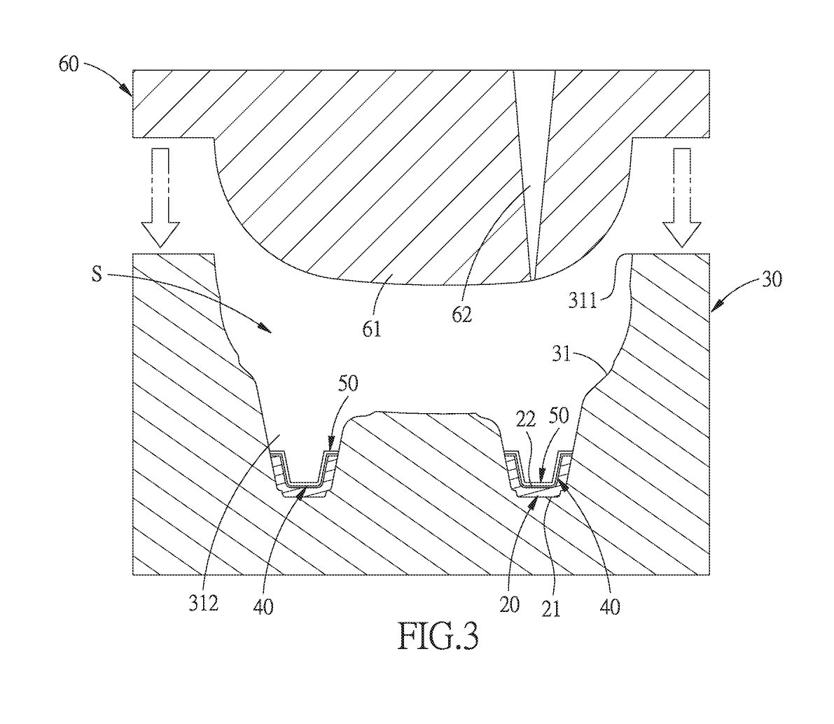

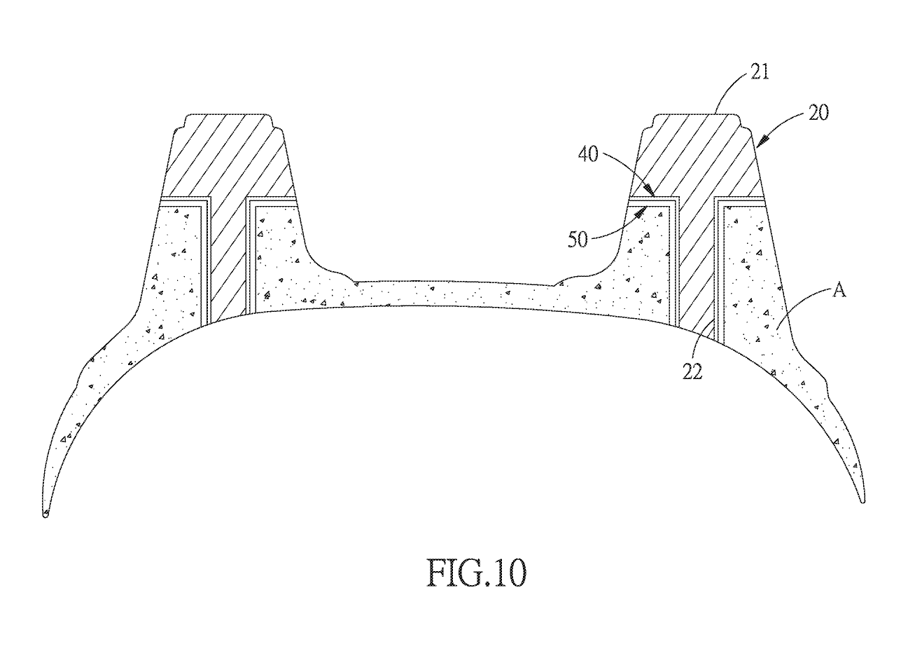

Shoe nail pre-forming step (I): forming a shoe nail 20. In this embodiment, the shoe nail 20 is made of thermosetting rubber. The shoe nail 20 has an outer surface 21 and a coupling surface 22. The coupling surface 22 shown in FIGS. 3-6, 8, 9 is a dent. The coupling surface 22 shown in FIG. 10 is a protruding post.

Shoe nail feeding step (II): referring to FIG. 3, putting the pre-formed shoe nail 20 in a first mold 30. The first mold 30 has a shaping chamber 31. The shaping chamber 31 has a slot 311. The shaping chamber 31 has therein a plurality of positioning portions 312. Each positioning portion 312 is a concave structure formed by denting the shaping chamber 31. The concave outline of each positioning portion 312 matches the outer surface 21 of a corresponding one of the shoe nails 20. The shoe nails 20 are received at the positioning portions 312 of the shaping chamber 31, respectively. The outer surfaces 21 of the shoe nails 20 abut against the positioning portions 312 of the shaping chamber 31, respectively. After the shoe nails 20 have been received in the shaping chamber 31, a shaping space S is defined by and between the shoe nails 20 and the slot 311 of the shaping chamber 31.

Surface treatment step (III): applying a liquid surface treatment agent to the coupling surface 22 of each shoe nail 20, wherein a surface treatment agent 40 is a butanone-based treatment agent, and the butanone-based treatment agent is butanone ethyl acetate to be applied and dried thereafter.

Adhesive glue feeding step (IV): referring to FIG. 3, putting an adhesive glue 50 in the shaping space S of the first mold 30, followed by applying the adhesive glue 50 to the surface treatment agent 40, wherein the adhesive glue 50 is liquid solvent-type PU glue.

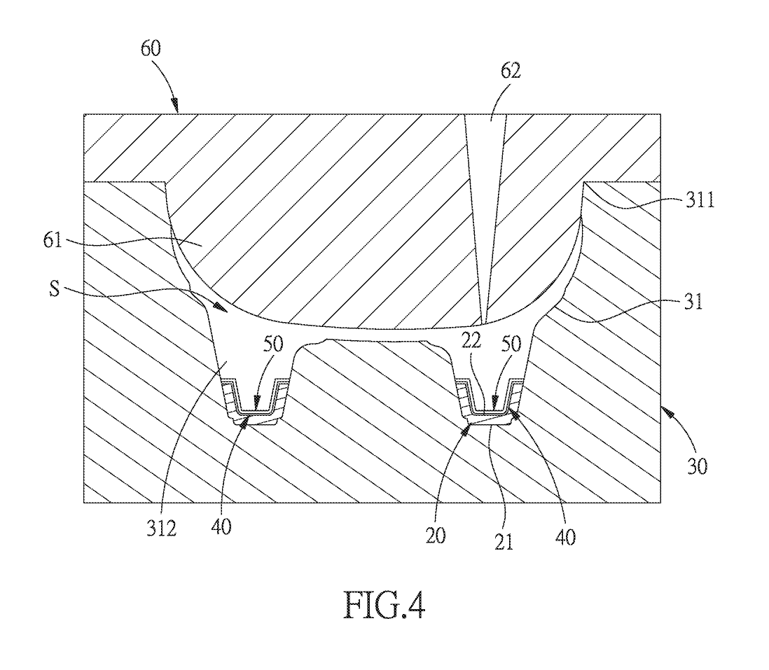

Die closing step (V): referring to FIG. 4, closing a second mold 60 and the first mold 30. The second mold 60 has a corresponding forming portion 61 which penetrates the second mold 60 to form a feeding passage 62. The corresponding forming portion 61 protrudes to match the shaping chamber 31 in shape. The corresponding forming portion 61 of the second mold 60 faces the shaping chamber 31 so as to close the second mold 60 and the first mold 30, seal the slot 311, and enable communication between the feeding passage 62 and the shaping space S.

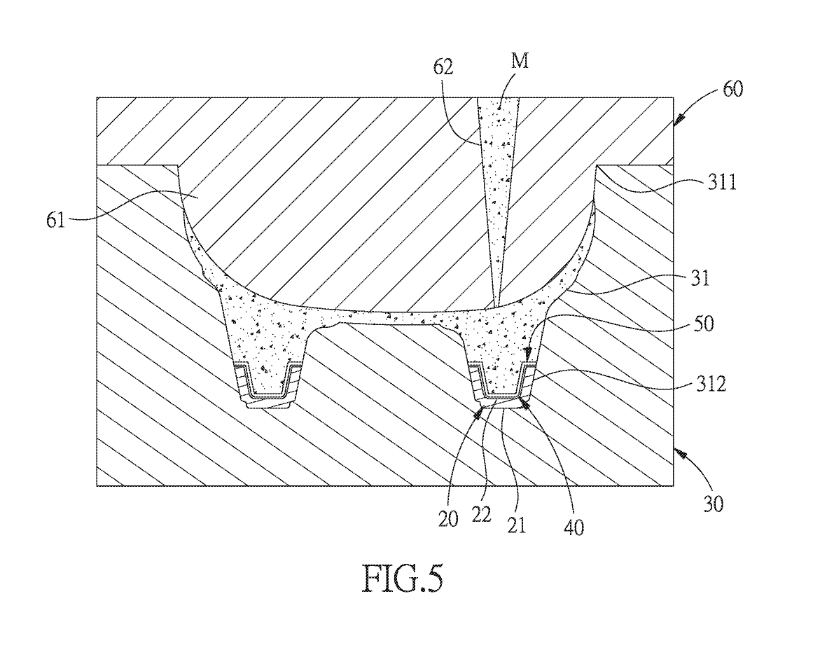

Sole material injecting step (VI): referring to FIG. 5, heating and melting a sole material M to a liquid state, followed by injecting the molten sole material M into the shaping space S via the feeding passage 62, wherein the sole material M is different from the material of which the shoe nails are made. In this embodiment, the sole material M is a molten thermoplastic polyurethane (TPU).

Melting binding step (VII): after the sole material M has been injected into the shaping space S, the heated molten sole material M is adhered and coupled to the coupling surface 22 of the shoe nail 20 by the adhesive glue 50; a cooling process is performed after the feeding of the sole material M has stopped and the adhesive glue 50 has melted; upon completion of the cooling process, the sole material M is cooled, cured, and turned into a sole A; upon completion of the cooling process, the adhesive glue 50 is cooled and solidified to therefore couple the sole A and the shoe nails 20 together.

Die opening step (VII): separating the first mold 30 and the second mold 60, followed by taking out the shoe nails 20 and the sole A coupled together through the adhesive glue 50.

The process flow of the method of manufacturing a sole with shoe nails made of different materials according to the present invention is described above. As indicated above, the present invention is characterized in that: the shoe nails 20 made of different materials are pre-formed; then, the shoe nails 20 are positioned between forming molds; the shoe nails 20 are coupled to the sole A being formed by means of the adhesive glue 50 and a conventional injection molding process; and the process is so simple that it increases production efficiency and economic benefits markedly.

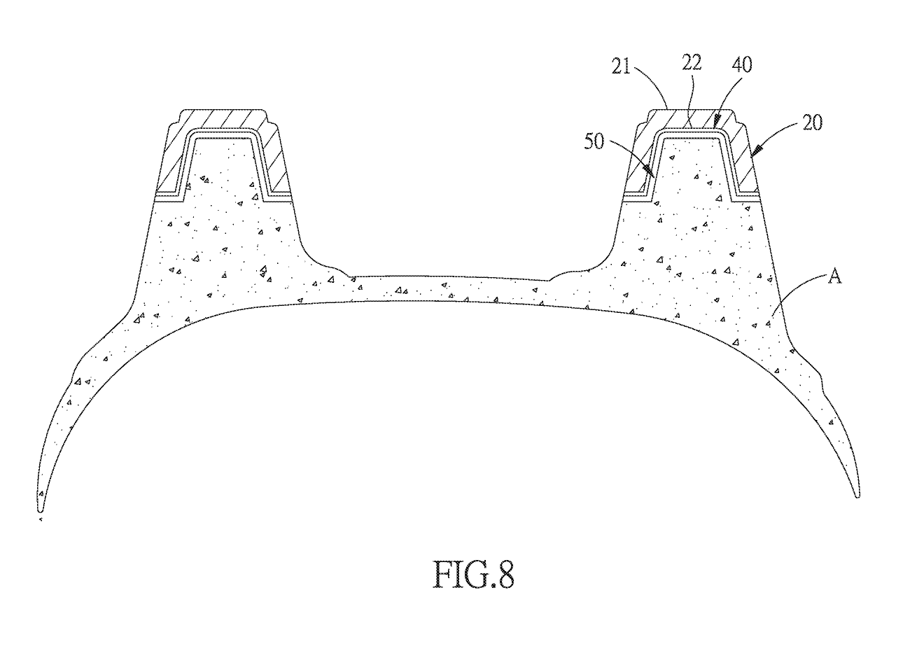

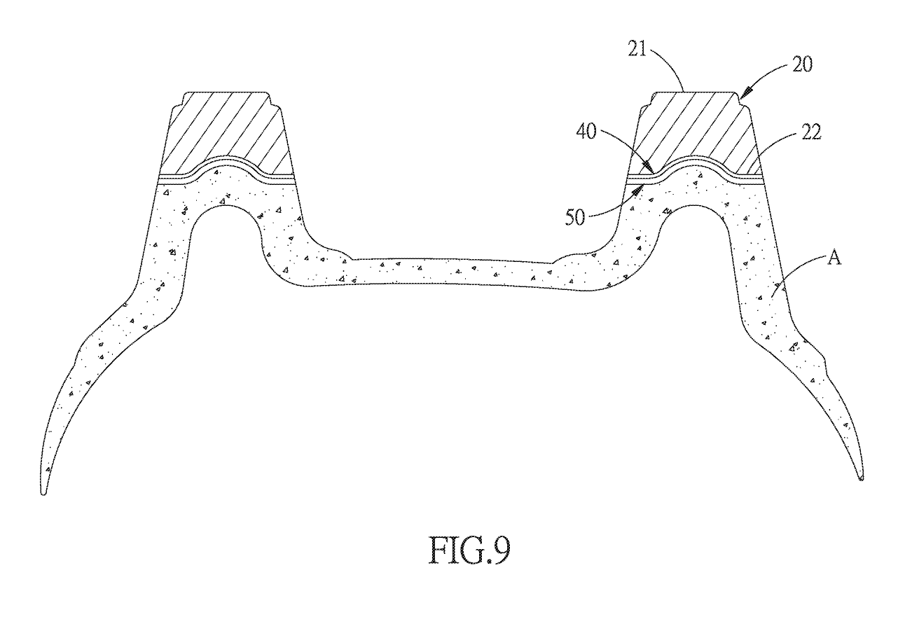

In addition, the present invention is not restrictive to the shape of the shoe nails 20. The shoe nails 20 which come in different shapes can be pre-formed, provided that the shapes of the positioning portions 312 of the first mold 30 are changed appropriately, and the shape of the corresponding forming portion 61 of the second mold 60 is changed appropriately, as shown in FIGS. 8, 9. Hence, the present invention is applicable to a sole with shoe nails which come in different shapes and made of different materials and thus demonstrates high practicability.

What is claimed is:

1. A method of manufacturing a sole with shoe nails made of different materials, comprising:
shoe nail pre-forming step: forming shoe nails each having an outer surface and a coupling surface;
shoe nail feeding step: putting the pre-formed shoe nails in a first mold, wherein the first mold has a shaping chamber, and the shaping chamber has a slot, wherein the shoe nails are received in the shaping chamber, and the outer surfaces of the shoe nails abut against the shaping chamber, wherein a shaping space is defined by and between the shoe nails and the slot of the shaping chamber, after the shoe nails have been received in the shaping chamber;
surface treatment step: applying a liquid surface treatment agent to the coupling surface of each said shoe nail, wherein the surface treatment agent is a butanone-based treatment agent to be applied and dried thereafter;
adhesive glue feeding step: putting an adhesive glue in the shaping space, followed by applying the adhesive glue to the surface treatment agent;
die closing step: closing a second mold and the first mold, wherein the second mold has a corresponding forming portion which penetrates the second mold to form a feeding passage, with the corresponding forming portion facing the shaping chamber, so as to close the second mold and the first mold, seal the slot, and enable communication between the feeding passage and the shaping space;
sole material injecting step: heating and melting a sole material to a liquid state, followed by injecting the molten sole material into the shaping space via the feeding passage, wherein the sole material is different from the material of which the shoe nails are made;
melting binding step: adhering and coupling the heated molten sole material to a coupling surface of each said shoe nail by the adhesive glue after the sole material has been injected into the shaping space, wherein a cooling process is performed after the feeding of the sole material has stopped and the adhesive glue has melted, such that the cooling process causes the sole material to cool, cure, and turn into a sole and causes the adhesive glue to cool, solidify, and thus couple the sole and the shoe nails together; and
die opening step: separating the first mold and the second mold, followed by taking out the shoe nails and the sole coupled together through the adhesive glue.

2. The method of claim 1, wherein the shoe nail is made of thermosetting rubber.

3. The method of claim 1, wherein the sole material is a molten thermoplastic polyurethane (TPU).

4. The method of claim 1, wherein the coupling surface is a protruding post.

5. The method of claim 1, wherein a plurality of positioning portions is disposed in the shaping chamber of the first mold, with each said positioning portion being a concave structure formed by denting the shaping chamber, wherein the concave outline of each said positioning portion matches the outer surface of a corresponding one of the shoe nails, wherein the shoe nails are received at the positioning portions in the shaping chamber, respectively, with the outer surfaces abutting against the positioning portions, respectively.

6. The method of claim 1, wherein the surface treatment agent in the surface treatment step is butanone ethyl acetate.

7. The method of claim 1, wherein the adhesive glue in the adhesive glue feeding step is liquid solvent-type PU glue.
